(19) United States
(12) Patent Application Publication
(10) Pub. No.: US 2025/0316088 A1
(43) Pub. Date: Oct. 9, 2025

(54) ARTIFICIAL INTELLIGENCE AUTOMATIC INTERVENTION SYSTEM AND METHOD OF USE THEREOF

(71) Applicant: DEEP SENTINEL CORP., Pleasanton, CA (US)

(72) Inventors: David SELINGER, Pleasanton, CA (US); Tomasz BORYS, Pleasanton, CA (US); David BRUMBAUGH, Mobile, AL (US); Marc DEVINCK, Pompton, NJ (US); Praveen NATARAJ, San Jose, CA (US)

(73) Assignee: DEEP SENTINEL CORP., Pleasanton, CA (US)

(21) Appl. No.: 19/173,493

(22) Filed: Apr. 8, 2025

Related U.S. Application Data
(60) Provisional application No. 63/631,429, filed on Apr. 8, 2024.

(51) Int. Cl. G06V 20/52; G06T 7/20

(52) U.S. Cl. CPC G06V 20/52; G06T 7/20; G06T 2207/30241

(57) ABSTRACT

Provided herein are systems for crime detection, deterrence, and intervention and methods of use thereof. The crime detection, deterrence, and intervention system employs an artificial intelligence module to reliably monitor and detect when crimes are in progress. A request to deploy a deterrence or intervention measure is evaluated by the artificial intelligence module to determine whether the requested deterrence or intervention measure should be automatically approved, automatically denied, or sent for further review and approval.

### CROSS-REFERENCE TO RELATED APPLICATIONS

This application claims priority to U.S. Patent Application No. 63/631,429 filed Apr. 8, 2024, which is incorporated by reference in its entirety.

### BACKGROUND

In recent years, there has been a major shift in crime. An increase in package delivery has driven a huge surge in the number of criminals who are stealing packages from doorsteps and other package drop off locations. Over 150 million stolen packages were reported in 2023 (in contrast with less than 40 million total reported property crimes in 2013). Furthermore, with the increase in the opioid and homelessness epidemic over the years, there has been an increase in the number of individuals likely to commit crimes, in urban centers and small towns alike.

These issues are exacerbated by police and criminal reform resulting in a reduced ability for police to act and a reduction in legal ramifications for committing crimes, and is further compounded by burglar alarms being less effective because of the very high false alarm rate, such as a 99% false alarm rate.

This has resulted in two clear crime trends: (1) an increase in outdoor and property crime, including package theft, vandalism, homeless encampments and associated waste/litter, car break-ins, and auto theft, among others; and (2) an increase in more extreme crimes such as smash-and-grabs, coordinated mass retail theft, and armed raids of storefronts, especially cash dominated businesses like cannabis dispensaries.

Existing solutions are unable to stop the most serious of these criminals, and due to the overall crime trend, police are overwhelmed and are unable to timely respond, if at all, to even the most serious crimes.

### SUMMARY

According to some embodiments, systems and methods for remote crime intervention are provided. The systems and methods described herein may include steps for monitoring an area using cameras and detecting potential crime threats using vision systems, other sensors and inputs, and artificial intelligence for advanced image recognition and threat response. According to some embodiments, systems and methods may be configured to transmit potential crime threats to a user for manual identification and verification at which point the user can request remote deployment of one or more intervention measures. The systems and methods can also be configured to compare deterrence scores for one or more intervention measures with threshold levels for one or more potential crime threats and deploy the one or more intervention measures if the deterrence scores for the one or more intervention measures are appropriate for the threshold levels for the one or more potential crime threats.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which like reference numerals refer to like elements throughout the different views:

FIG. 1A is a flow chart of an artificial intelligence crime monitoring and intervention deployment method according to some embodiments.

FIG. 1B is a flow chart of an artificial intelligence crime monitoring method according to some embodiments.

FIG. 1C is a flow chart of an artificial intelligence crime monitoring method according to some embodiments.

FIG. 2 is a flow chart of a crime intervention deployment method with multifactor approval according to some embodiments.

FIG. 3 depicts a structural view of an exemplary camera having a threat detection engine according to some embodiments.

FIG. 4 depicts a schematic overview of an exemplary computing device according to some embodiments.

### DETAILED DESCRIPTION

The subject matter disclosed herein relates to systems and methods for monitoring, detecting, preventing, or intervening potential crime threats. More specifically, some embodiments relate to an artificial intelligence augmented camera security system with deployable intervention measures.

Security monitoring systems may be used to observe and record activity in both public and private spaces. Traditional surveillance systems rely heavily on human operators to monitor video feeds and identify suspicious activity. However, relying on human operators can be labor intensive, inefficient, and error prone, particularly when monitoring a large number of cameras or locations. Therefore, as recognized by the inventors, there is a need for a remote and automatic intervention system which can monitor and detect suspicious activity in progress and deploy appropriate intervention measures.

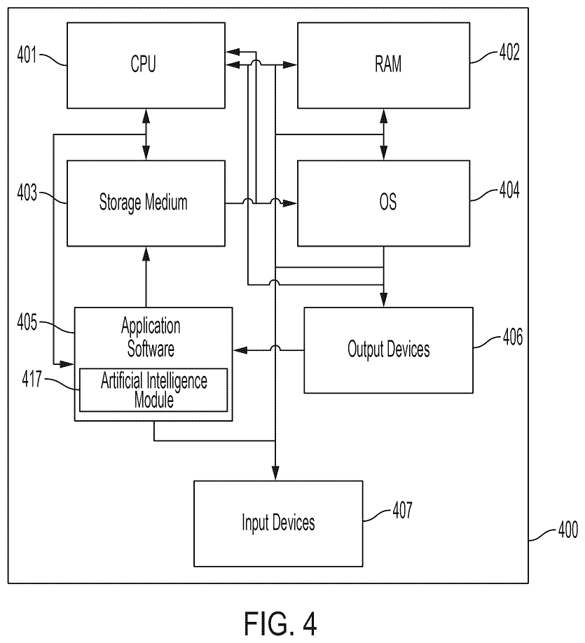

Security systems utilizing cameras, area sensors, and other detection methods have existed for a long time. Known security systems have leveraged remote detection capabilities, e.g., cameras and area sensors, to quickly alert users of a potential threat but lack the ability to actually prevent or intervene said threat. Similarly, non-lethal deterrents such as pepper spray, sirens, light strobes, and ammunition blanks have been widely used by the police and private citizens alike to dispel potential or actual threats and protect individuals and/or property, but simply having access to such deterrents does not mean they are available to be deployed in real time. According to some embodiments, monitoring systems may be combined with advanced artificial intelligence models (e.g., artificial intelligence module 417 as depicted in FIG. 4), manual verification, or both, to provide a system which monitors for potential crime threats and intervenes in the case a credible threat is recognized. According to some embodiments, the systems and methods may provide a practical application of automated security monitoring. According to some embodiments, the systems and methods may address the technical problem of accurately detecting security threats in real-time using video data from security cameras or other sensors and deploying automated or manual intervention measures. Although detecting security threats with video data has traditionally required continuous human supervision that is prone to delays or errors, the systems and methods according to some embodiments provide a technical solution that automatically processes video feeds, identifies security threats based upon severity, and recommends appropriate intervention measures.

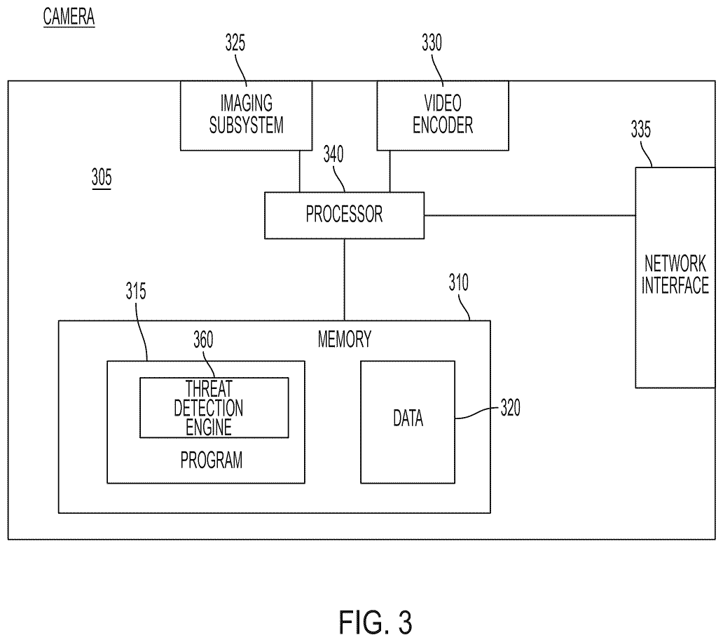

In some embodiments, one or more motion active cameras (e.g., as depicted in FIG. 3) can be used to monitor an area. Artificial intelligence module 417 may process the video feed from each camera to determine a potential threat, filtering out potential threats or actors (such as humans) from typically harmless objects (such as cars or animals). Artificial intelligence module 417 may further evaluate aggravating or mitigating circumstances, such as presence of a weapon, speed and trajectory of any potential threats, frequency of crime in an area, and the available intervention measures available at a threat location, among others. A user, such as a security guard (who may be on site or at a remote location), may then be notified of the potential threat for manual review and request deployment of one or more intervention measures. Based on the requested intervention measure and the level of the threat, the intervention measure may be automatically deployed, the request may be automatically denied, or the request may be sent for additional review.

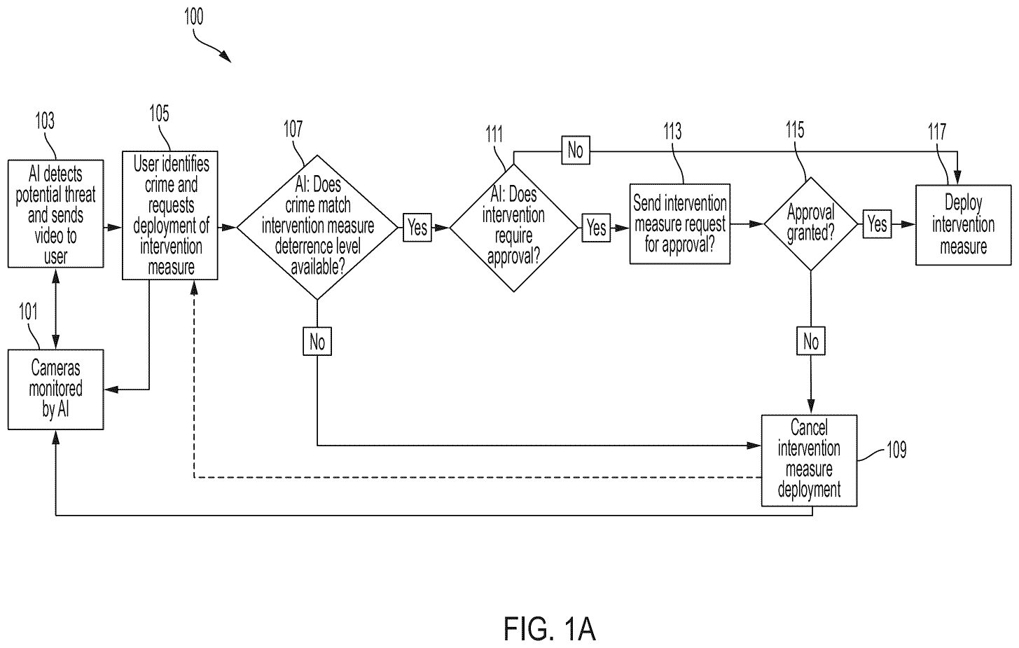

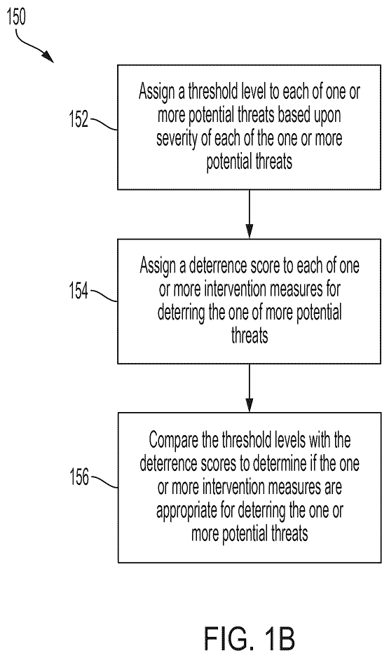

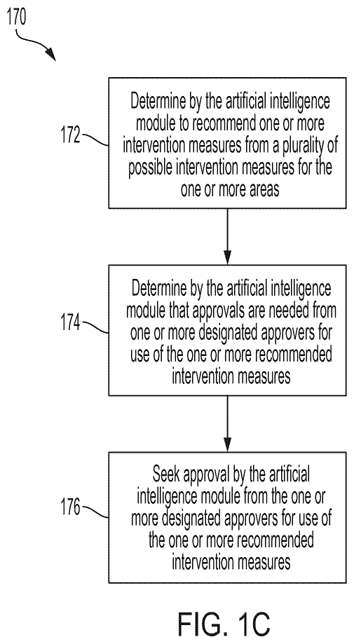

Referring now to FIG. 1A, shown is a flow chart of an artificial intelligence crime monitoring and intervention deployment method 100 according to some embodiments. In step 101, a security system including one or more cameras (e.g., camera 305 in FIG. 3) may be used to monitor one or more areas. The one or more areas may be monitored by one or more artificial intelligence modules 417 (as depicted in FIG. 4). In some embodiments, the artificial intelligence module 417 may be located on the camera or may be remote from the camera. The video feed of the cameras may be monitored by the one or more artificial intelligence modules 417 for potential threats, and any perceived threat may be further reviewed by one or more artificial intelligence modules 417 in step 103. The artificial intelligence modules 417 may process the video feed obtained by the one or more cameras used to detect or identify one or more potential threats in an area (or areas) being monitored by the one or more cameras. In some embodiments, the cameras may be motion activated and begin transmitting the video feed to artificial intelligence module 417 when motion is detected in frame. In some embodiments, the cameras may include the artificial intelligence module 417. In some embodiments, the camera data may be augmented by data from one or more additional sensors, such as motion sensors. In some embodiments, the artificial intelligence module 417 may also process information input by one or more users. In some embodiments, the artificial intelligence module 417 may also process information from switches located in the area being monitored (which alert the crime monitoring system about potential threats).

Artificial intelligence module 417 may take several different forms (e.g., neural network, linear regression, decision tree, support vector machine, etc.). In some embodiments, artificial intelligence module 417 may rely on a combination of hardware and/or software. In some embodiments, artificial intelligence module 417 may be a software program stored in memory. In some embodiments, artificial intelligence module 417 may be a neural network, such as a convolutional neural network, attention-based neural network, or a recurrent neural network. Example convolutional neural networks may include AlexNet, ResNet, or GoogLeNet, among other possibilities. Example attention-based neural networks may include encoder-only, decoder-only, or encoder-decoder transformer neural networks, among other possibilities. Example recurrent neural networks may include a Hopfield bidirectional associative memory network, a long short-term memory network, or a recurrent multilayer perceptron network, among other possibilities. Training machine learning models may involve minimizing a loss function. For example, the loss function for training may be based on the resistive predictions and real-world measurements. According to some embodiments, the loss function may be any suitable loss function, such as a cross-entropy loss function, a contrastive loss function, a focal loss function, a mean square error (MSE) loss function, or a mean absolute error (MAE) loss function, although it should be understood other loss functions and combinations of loss functions are also possible. Once trained, artificial intelligence module 417 may be able to automatically analyze video feed from one or more monitoring cameras, detect and classify potential threats, and assign deterrence scores to one or more intervention measures or threshold levels to one or more potential threats.

According to some embodiments, artificial intelligence module 417 may be trained on labeled video datasets, video frame datasets, or a combination of video and video frame datasets to identify objects, individuals, or environmental elements relevant to security or threat monitoring. In some embodiments, transfer learning may be employed to initialize an artificial intelligence model, such as a convolutional neural network, with weights derived from a more general task, such as object detection and may then be fine-tuned on a domain specific dataset comprising security or threat scenarios. In some embodiments, artificial intelligence module 417 may be executed on a machine-learning framework or platform, for example, a machine-learning framework employing a neural network, such as, but not limited to, an autoencoder neural network. Some possible advantages of using autoencoder type neural network frameworks over other methods may be that autoencoder type neural network frameworks require a smaller number of images or videos for training, can be trained on live data in real time, can be used to label or videos images, and/or can be used for self-learning. In some embodiments, artificial intelligence module 417 can recognize potential crime threats by using methods such as region-based convolutional neural networks (R-CNNs), you only look once (YOLO) real-time object recognition, models from the DETR family, multimodal large language models (LLMs), or other methods that rely on qualitative spatial reasoning (QSR). According to some embodiments, artificial intelligence module 417 may also be trained with data including, but not limited to, customer demographics and other information, crime statistics, other sensor data, and text and other information provided by humans.

In step 103, one or more artificial intelligence modules 417 may review the video feed, and any additional sensor data or other inputs, for a potential threat. The system may repeat steps 101 and 103 with the cameras recording and transmitting the video feed to artificial intelligence module 417 for evaluation until a credible threat is detected. Once a credible threat is detected, the video feed and additional data may be transmitted to a user, such as a security guard, for further review. In some embodiments, artificial intelligence interpretability data, which helps explain how the one or more artificial intelligence modules 417 arrived at their output, may also be transmitted to a user for further review.

In step 105, the user may review the video feed assessed by artificial intelligence module 417 to verify if there is a potential threat. If no threat is detected, the method 100 proceeds back to step 101. If the user identifies a threat, the user may request deployment of one or more intervention measures. In some embodiments, intervention measures may include, but are not limited to, for example, two way voice or video, strobe lights, sirens, ammunition blanks, sirens, air horns, or other non-contact measures, or any combination thereof, which alerts the potential threat they are being monitored. In some embodiments, intervention measures may include, but are not limited to, for example, pepper spray or pepper balls, pellet or paint ball guns, dyes or UV dyes, water, rubber bullets, smoke bombs, flashbangs, or other deployable means of contact, which may or may not include individually identifiable information, such as DNA, or any combination thereof. In some embodiments, if one or more intervention measures are requested the system may automatically alert local authorities. In some embodiments, intervention measures may have multiple locations which can be selectively deployed. In some embodiments, intervention measures may have variable deployment, in which case either the user or the artificial intelligence module 417 specifies the direction, intensity, or other settings of variable deployment. In some embodiments, intervention measures may be attached to a movable platform which may include, but is not limited to, turrets, vehicles, or flying vehicles (sometimes referred to as drones).

In step 107, artificial intelligence module 417 may determine if the requested intervention measure matches the potential threat as assessed by artificial intelligence module 417 and/or the user. If the requested intervention measure is not appropriate, the system proceeds to step 109, whereby the request for an intervention measure is cancelled, and the method 100 proceeds back to step 101. If the requested intervention measure is appropriate the method proceeds to step 111. In some embodiments, a scoring system may be used whereby each intervention measure is associated with a deterrence score and crimes or potential threats are associated with a respective threshold level, the deterrence score and threshold level being based on potential harm. For example, intervention measures such as activating two way voice communication may have a low deterrence score since the potential of harm is low, whereas pepper spray may have a high deterrence score since the potential of harm is high. Similarly, crimes such as package theft may have a low threshold level, whereas an armed robbery may have a high threshold level warranting any measures necessary. The deterrence scores for the one or more intervention measures may be compared against the threshold levels for the one or more potential threats to determine if the requested one or more intervention measures are appropriate given the circumstances. In some embodiments, the deterrence score of each intervention measure and the threshold level of a crime or potential threat are set by a user, the artificial intelligence module 417, a third party such as law enforcement or government agencies, or a combination thereof. In some embodiments, the deterrence score of each intervention measure and the threshold level of a crime or potential threat may be dynamically changing variable(s) based on, for example, environmental factors (such as the time of day or historic use) and/or efficacy data training the artificial intelligence module 417.

FIG. 1B is a flow chart of an artificial intelligence crime monitoring method 150 according to some embodiments. According to some embodiments, the method 150 may be used to implement aspects of step 107 in FIG. 1A.

In step 152, a threshold level is assigned to each of one or more potential threats based upon severity of each of the one or more potential threats.

In step 154, a deterrence score is assigned to each of the one or more intervention measures for deterring the one or more potential threats.

In step 156, the threshold levels are compared with the deterrence scores to determine if the one or more intervention measures are appropriate for deterring the one or more potential threats.

In step 111 of FIG. 1A, artificial intelligence module 417 may determine if the requested intervention measure requires approval. In some embodiments, if the artificial intelligence module 417 in step 111 determines that no approval is required, the method proceeds to step 117, and the requested intervention measure is deployed; otherwise the method proceeds to step 113.

In step 113, a request to approve the requested intervention measure may be sent to a user or a third party for approval. In some embodiments, certain intervention measures may require additional confirmation or third party approval. For example, some intervention measures may require the user to confirm the deployment or a third party to review the video feed or recording of the potential threat and make an independent evaluation of whether to deploy the intervention measure. In some embodiments, the need to approve the requested intervention measure may be based on the particular requested intervention measure, user preferences, and/or an assessment by artificial intelligence module 417 of the potential threat, local laws, or industry standards, although not limited thereto.

In some embodiments, the artificial intelligence module 417 may automatically seek approval from one or more designated approvers. The designated approvers may be for example one or more of: a user (e.g., a guard, a lead guard, a monitor of security monitoring company, a manager of a security monitoring company, LSC shift lead or manager 217); a customer 219; a designated senior user 221 (e.g., LSC executive); or any combination thereof. The artificial intelligence module 417 may automatically determine which one or more designated approvers to seek approval from based on one or more of, for example, the potential threat, type of crime, requested intervention measure, customer preferences, local laws, or industry standards.

In some embodiments, the artificial intelligence module 417 may escalate the approval through various levels of approval automatically based on the severity of the requested intervention measure. In some embodiments, if the artificial intelligence module 417 needs to seek approval from two or more designated approvers, the artificial intelligence module 417 may automatically determine to seek the approvals in parallel, serially, or any combination thereof. The artificial intelligence module 417 may automatically determine the order of seeking approvals by one or more of, for example, the potential threat, type of crime, requested intervention measure, customer preferences, local laws, or industry standards. For example, for a particular potential threat, the artificial intelligence module 417 may determine that approval needs to be sought sequentially: firstly from a guard first; and once approved by the guard, secondly from a designated senior user. For example, for a combination of a different particular potential threat and a requested intervention measure, the artificial intelligence module 417 may determine that approval needs to be sought in parallel from a guard, a designated senior user, and a customer.

In some embodiments, when seeking the approval from designated approvers, the artificial intelligence module 417 may automatically contact one or more, for example, devices, apps, or messaging accounts associated with each designated approver. When responding back to the artificial intelligence module 417, the designated approver may reply using the same or different device, app, or messaging account that received the request for approval from the artificial intelligence module 417.

FIG. 1C is a flow chart of an artificial intelligence crime monitoring method 170 according to some embodiments. According to some embodiments, the method 170 may be used to implement aspects of step 107, step 111, and step 113 in FIG. 1A.

In step 172, the artificial intelligence 417 module may determine to recommend one or more intervention measures from a plurality of possible intervention measures for the one or more areas being monitored. The artificial intelligence module 417 may determine the one or more recommend intervention measures from the plurality of possible intervention measures based on the one or more identified potential threats in the one or more areas. In some embodiments, step 172 may be implemented by method 150 of FIG. 1B. For example, determining the one or more recommended intervention measures by the artificial intelligence module 417 may include: assigning by the artificial intelligence module 417 a deterrence score to each of the plurality of intervention measures for deterring one or more potential threats identified in the one or more areas.

In step 174, the artificial intelligence module 417 may determine that approvals are needed from one or more designated approvers for use of the one or more recommended intervention measures. The artificial intelligence module 417 may determine the needed approvals based on the one or more identified potential threats in the one or more areas, the one or more recommend intervention measures, or a combination thereof.

The artificial intelligence module 417 may further determine an order for seeking approvals from two or more of the designated approvers. The artificial intelligence module 417 may determine the order for seeking approvals from the two or more designated approvers based on one or more potential threats identified in the one or more areas, the one or more recommended intervention measures, or a combination thereof. For example, the order for seeking approvals from the two or more designated approvers may include seeking approval of a first designated approver before seeking approval of a second designated approver. In some embodiments, the artificial intelligence module 417 may determine the needed approvals and an order for seeking the needed approvals based on one or more potential threats identified in the one or more areas, the one or more recommend intervention measures, or a combination thereof. In some embodiments, the one or more designated approvers may include two or more of: a guard, a lead guard, a monitor of security monitoring company (e.g., LCS shift lead 217), a manager of a security monitoring company (e.g., LCS manager 217), a customer (e.g., customer 219), or a designated senior user (e.g., senior user 221).

In step 176, the artificial intelligence module 417 may seek approval by the artificial intelligence module from the one or more designated approvers for use of the one or more recommended intervention measures. In some embodiments, seeking approval by the artificial intelligence module 417 from the one or more designated approvers for use of the one or more recommended intervention measures may include forwarding to the one or more designated approvers information used to determine the one or more recommended intervention measures, such as, for example, the deterrence score for each of the one or more recommended intervention measures determined in step 172.

In step 115 of FIG. 1A, the request to approve the deployment of the intervention measure may be either: approved and the system proceeds to step 117, and the intervention measure is deployed; or the request is denied, the system proceeds to step 109, and the requested intervention measure is cancelled. In some embodiments, in step 109 when the requested intervention measure is cancelled, the cancellation is transmitted back to the user in step 105 whereby the user may request deployment of the same or a different intervention measure.

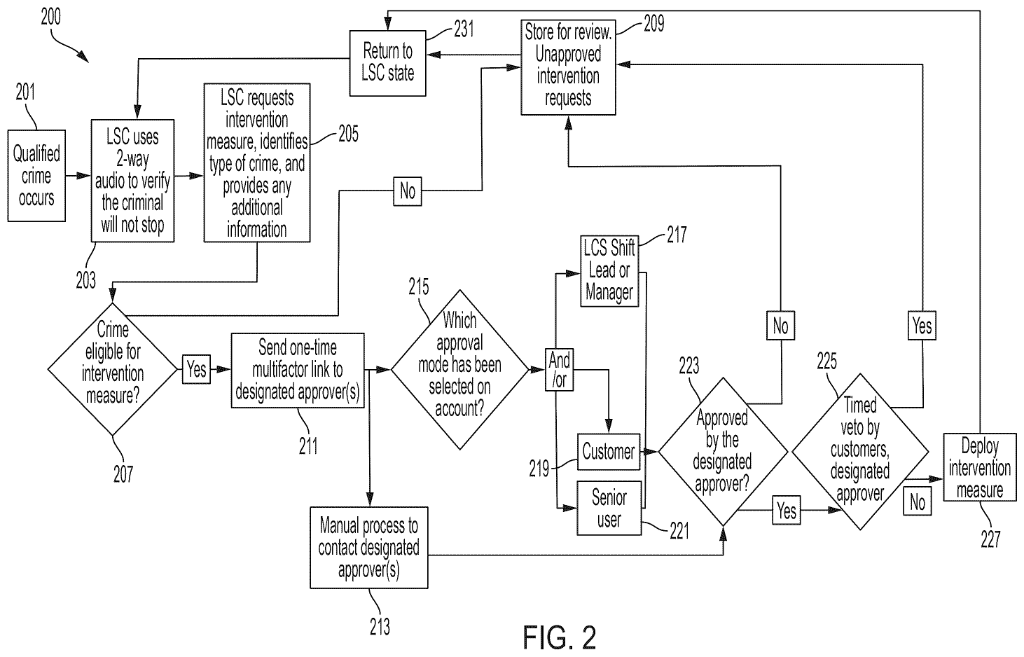

Referring now to FIG. 2, shown is a flow chart of a crime intervention deployment method 200 with multifactor approval according to some embodiments. In step 201, a qualified crime may occur (for example, package theft, attempted break in, or property vandalism, although not limited thereto) and may be detected by the system. In step 203, once a qualified crime occurs, a user, such as a representative of a live sentinel center (LSC) or guard, monitoring the security system may use two-way audio to deter the criminal and verify the criminal will not stop. The user may be a human being located on site and/or remote to the area being monitored.

In step 205, the user, such as a LSC representative, having verified the criminal will not stop, may send a request to trigger an intervention measure, submit the type of crime in progress, and provide any additional information, for example, if the criminal is armed, if the crime being committed is a violent crime, or if the crime is being committed at an occupied location, although not limited thereto. For example, the user may: push a button (e.g., a hardware or software button) that identifies the desired intervention measure; and identify the type of crime (e.g., select from a list including, for example, armed criminal, violent crime, occupied break in, or other). The method then proceeds to step 207.

In step 207, the method may determine if the crime submitted in step 205 is eligible for the requested intervention measure. In some embodiments, this determination is performed by artificial intelligence module 417. If the crime is not eligible, the request and surrounding circumstances may be stored in step 209 in a database for review. If the crime is eligible for the requested intervention measure, the method proceeds to step 211.

In step 211, a one-time multifactor approval link may be generated and sent to a designated approver (e.g., via email, Slack, text message, or any other messaging system). In some embodiments, artificial intelligence module 417 may annotate the information provided to the designated approver to assist in effective, rapid decision-making. In some embodiments, artificial intelligence module 417 may identify potential risks with the deployment and provide these potential risks in the information provided to the designated approver, thereby notifying the designated approver (or another party) of these potential risks. In some embodiments, the one-time multifactor approval link may provide access to video footage (e.g., a livestream, stored video, or snapshots) of the one or more potential threats and a feedback mechanism for the user to approve or deny one or more recommended intervention measures. In some embodiments, the one-time multifactor approval link may include: a link to a livestream, stored video, or snapshots of the crime in progress, account notes, or “approve” and “deny” buttons. In some embodiments, additional sensor data may be sent to a designated approver. In some embodiments, artificial intelligence interpretability data, which helps explain how the one or more artificial intelligence modules 417 arrived at their outputs, may also be transmitted to a designated approver.

According to some embodiments, in step 213, the one-time multifactor link may be routed manually to the designated approver, and the designated approver can approve or deny, in step 223, the one or more recommended intervention measures. According to some embodiments, the manual process may include a Slack, text message, or any other communication system message. According to some embodiments, the manual process may include a telephone call to the designated approver, which may or may not include forwarding the one-time multifactor link.

In some embodiments, in step 215, the one-time multifactor link may be routed automatically to the designated approver. In some embodiments, the one-time multifactor link may be automatically routed to one or more of a designated user, such as a LSC shift lead or manager, 217, a customer 219, or a designated senior user, such as a LSC executive, 221, depending on customer preferences, type of crime, or requested intervention measure, although not limited thereto. In some embodiments, certain intervention measures may require approval from both the customer 219 and the senior user 221.

In step 223, the designated approver may either approve or deny the requested intervention measure. According to some embodiments, the designated approver may access the one-time multifactor link sent in step 211 on a mobile computing device (e.g., a mobile phone or a tablet) or a desktop computing device. According to some embodiments, the designated approver may view the linked video or view the snapshots to verify that a criminal activity is occurring. According to some embodiments, the designated approver may select the “approve” or “deny” button sent with the one-time multifactor link in step 211.

If the request is denied, the request and surrounding circumstances may be stored in step 209 in a database for review. If the request is approved, the method 200 proceeds to step 225. In some embodiments, approved requests may also be stored in step 223 in a database for review.

In step 225, the customer 219 or a senior user 221 may veto the approval within a set time (for example, within 15 seconds of the approval, although not limited thereto) to override the designated approver. If the request is vetoed, the request and surrounding circumstances may be stored in step 209 in a database for review. If the veto is declined or the set time to veto has elapsed, the requested intervention measure is deployed in step 227.

In step 227, the intervention measure may be deployed. When the intervention measure is deployed, information of the deployment may be disseminated. In some embodiments, customer 219, users such as LSC department head(s), and/or users such as customer care may be notified of the deployment. In some embodiments, an automated ticket in a tracking system, such as Zendesk or HubSpot, may be initiated when the deployment occurs. The notification of the deployment of the intervention measure may include a video link to the event in an administration dashboard.

In step 231, the system returns a monitoring state by the LSC. In some embodiments, the information stored in the database in step 209, the information stored in the database in step 223, the records regarding deployed one or more intervention measures from step 227, the records regarding one or more unapproved intervention requests from step 209 may be used for disciplinary or training purposes, or used to train artificial intelligence module 417.

FIG. 3 depicts a structural view of an exemplary camera 305 having a threat detection engine according to some embodiments. According to some embodiments, one or more cameras 305 may be used to implement steps 101 and 103 of FIG. 1A. According to some embodiments, one or more cameras camera 305 may be used to implement steps 101, 103, 107, 111, 113, 115, and 117 of FIG. 1A. According to some embodiments, one or more cameras 305 may be used to implement step 201 of FIG. 1A. In some embodiments, the exemplary camera 305 may be positioned in a fixed location. In some embodiments, the exemplary camera 305 may be attached to a movable platform, which may include, but is not limited to, turrets, vehicles, or flying vehicles (sometimes referred to as drones).

In FIG. 3, the block diagram of the exemplary camera 305 may include a processor 340 that is in communication with memory 310. The depicted memory 310 may include program memory 315 and data memory 320. The program memory 315 may include processor-executable program instructions implementing threat detection engine 360. The threat detection engine 360 may implement the functions of the artificial intelligence module 417. The processor 340 may be operatively coupled to imaging subsystem 325 and video encoder 330. In some embodiments, the imaging subsystem 325 may include a high-definition imaging sensor. In some embodiments, the imaging subsystem 325 may include a night vision imaging sensor. In some embodiments, the imaging subsystem 325 may include an audio sensor (microphone). In some embodiments, the imaging subsystem 325 may include an audio speaker. In some embodiments, the imaging subsystem 325 may be connected to an external audio sensor and/or audio speaker. In some embodiments, the imaging subsystem 325 may have the ability to change direction. In some embodiments, the imaging subsystem 325 may have the ability to zoom to widen or narrow the field of view. In some embodiments, the video encoder 330 may be an MPEG encoder. In some embodiments, the video encoder 330 may be an H.264 encoder. In some embodiments, the video encoder 330 may be an H.265 encoder. In some embodiments, the processor 305 may be communicatively coupled to network interface 335.

FIG. 4 depicts a schematic overview of an exemplary computing device 400 according to some embodiments. According to some embodiments, the camera 305 may be implemented using aspects of a computing device 400. According to some embodiments, a computer used by users, such as the LSC or a guard, or a computer used by a customer may be implemented using aspects of a computing device 400. According to some embodiments, a computing device 400 may be used to implement one or more of steps 105, 107, 111, 113, 115, or 117 and provide a response to steps 113 in FIG. 1A. According to some embodiments, one or more computing devices 400 may be used to implement one or more of steps 203, 205, 207, 211, 213, 215, 223, 225, or 227 performed by a user, such as an LSC representative, in FIG. 2. According to some embodiments, one or more computing devices 400 may be used to implement one or more of steps 217, 219, 221, or 225 in FIG. 2.

In FIG. 4, the computing device 400 is shown and may generally be comprised of: a Central Processing Unit (CPU) 401; optional further processing units, such as a graphics processing unit (GPU); non-transitory computer-readable medium, such as a Random Access Memory (RAM) 402 or alternatively/additionally a storage medium 403 (e.g., read only memory (ROM), hard disk drive, solid state drive, flash memory, cloud storage); an operating system (OS) 404; one or more application software 405 (including, but not limited to, artificial intelligence module 417), one or more output devices/means 406 (e.g., LCD screen, LED display, OLED panel); and one or more input devices/means 407 (e.g., keyboard, mouse, microphone, scanner, camera). According to some embodiments, the one or more output devices/means 406 and the one or more input devices/means 407 may be combined in a single device, such as one or more touchscreens or one or more communication interfaces (e.g., RS232, Ethernet, Wifi, Bluetooth, USB) (such as the network interface 335 in FIG. 3). The OS 404 and the one or more application software 405 may be stored in the RAM 402 and/or the storage medium 403. The components of the computing device may be connected directly or indirectly to one or more printed circuit boards (such as a mother board). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms. In some embodiments, one or more computing devices 400 may perform the operations described with respect to FIGS. 1 and 2. In some embodiments, the computing device or devices may be located locally, and in others they may be located remotely, or they may be a combination of local and remote.

According to some embodiments, a computer system having two or

more computer devices 400 may be employed to implement the methods of FIGS. 1 and 2. According to some embodiments, data may be transferred to the computing system, stored by the computing system and/or transferred by the computing system to users of the computing system across local area networks (LANs) (e.g., office networks, home networks), wireless networks (e.g. cellular networks, Wi-Fi networks), or wide area networks (WANs) (e.g., the Internet). In one or more embodiments, the computing system may be comprised of numerous servers communicatively connected across one or more LANs and/or WANs. One of ordinary skill in the art would appreciate that there are numerous manners in which the computing system could be configured and embodiments of the present disclosure are contemplated for use with any configuration.

According to some embodiments, the systems and methods provided herein may be employed by a user of a computing device 400 whether connected to a network or not. Similarly, some steps of the methods provided herein may be performed by components and modules of the computing system whether connected or not. While such components/modules may be offline, the data they generate may then be transmitted to the relevant other parts of the computing system once the offline component/module comes online again with the rest of the network (or a relevant part thereof). According to an embodiment of the present disclosure, some of the applications of the present disclosure may not be accessible when not connected to a network; however, a user or a module/component of the computing system itself may be able to compose data offline from the remainder of the system that will be consumed by the system or its other components when the user/offline system component or module is later connected to the system network.

As would be understood by one of ordinary skill in the art, a computer program may include a finite sequence of computational instructions or program instructions. It will be appreciated that a programmable apparatus or computing device 400 can receive such a computer program and, by processing the computational instructions thereof, produce a technical effect.

A programmable apparatus or computing device (such as computing device 400) may be used to implement one or more embodiments disclosed herein. The programmable apparatus or computing device 400 may include one or more microprocessors, microcontrollers, embedded microcontrollers, programmable digital signal processors, programmable devices, programmable gate arrays, programmable array logic, memory devices, application specific integrated circuits, graphical processing units, artificial intelligence accelerators, quantum processing units, or the like, which can be suitably employed or configured to process computer program instructions, execute computer logic, store computer data, and so on. It will be understood that the computing device can include one or more non-transitory computer-readable medium (e.g., RAM 402 and/or storage medium 403) and that this medium may be internal or external, removable and replaceable, or fixed. It will also be understood that a computing device can include a Basic Input/Output System (BIOS), firmware, an operating system (e.g., OS 404), a database, or the like that can include, interface with, or support the software and hardware described herein.

Some embodiments of the system as described herein are not limited to applications involving conventional computer programs or programmable apparatuses that run them. It is contemplated, for example, that some embodiments may include an optical computer, quantum computer, analog computer, or the like.

Regardless of the type of computer program or computing device involved, a computer program can be loaded onto a computing device to produce a particular machine that can perform one or more of the computer-implemented functions disclosed herein. This particular machine (or networked configuration thereof) provides a technique for carrying out one or more of the computer-implemented functions disclosed herein.

Any combination of one or more non-transitory computer-readable medium(s) (or non-transitory computer-readable memory, or non-transitory computer-readable storage medium(s)) may be utilized. A non-transitory computer-readable medium may be, for example, but not limited to, an electronic, magnetic, optical, electromagnetic, infrared, or semiconductor system, apparatus, or device, or any suitable combination of the foregoing. Illustrative examples (a non-exhaustive list) of a non-transitory computer-readable medium may include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer-readable medium may be any tangible medium that can contain, or store a program for use by or in connection with an instruction execution system, apparatus, or device.

According to some embodiments, a data store may be used with the database of step 209 or step 223. As an example, a data store may be comprised of one or more of a database, file storage system, relational data storage system or any other data system or structure configured to store data. The data store may be a relational database, working in conjunction with a relational database management system (RDBMS) for receiving, processing, and storing data. A data store may comprise one or more databases for storing information related to the processing of moving information and estimate information as well one or more databases configured for storage and retrieval of moving information and estimate information.

According to some embodiments, computer program instructions may be stored in a non-transitory computer-readable medium capable of directing a computer or other programmable data processing apparatus (e.g., one or more processors) to function in a particular manner. The instructions stored in the non-transitory computer-readable medium may constitute an article of manufacture including computer-readable instructions for implementing one or more of the computer-implemented functions disclosed herein.

Program code and/or data embodied on a non-transitory computer-readable medium may be transmitted using any appropriate technique, including but not limited to wireless, wireline, optical fiber cable, RF, etc., or any suitable combination of the foregoing. According to some embodiments, the network interface 335 in FIG. 3 may use such transmission techniques.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction techniques for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, Python, Rust, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, some embodiments of the system as described herein can take the form of web-based computer software, which may include client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, one or more methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, one or more combinations of the foregoing, or the like. Therefore, embodiments that process computer program instructions, computer-executable code, or the like can suitably act upon the instructions or code in one or more of the ways just described.

According to some embodiments, the functions and operations presented herein are not inherently related to any particular computing device or other apparatus. Various general-purpose systems may also be used with programs in accordance with the teachings herein, or it may prove convenient to construct more specialized apparatuses to perform the required method steps. The required structure for a variety of these systems will be apparent to those of ordinary skill in the art, along with equivalent variations. In addition, embodiments of the disclosure are not described with reference to any particular programming language, and one of ordinary skill in the art would appreciate that a variety of programming languages may be used to implement the techniques described herein. Some embodiments are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

As disclosed herein, block diagrams and flowchart illustrations depict methods, apparatuses (e.g., systems), and non-transitory computer-readable mediums. Each element of the block diagrams and flowchart illustrations, as well as each respective combination of elements in the block diagrams and flowchart illustrations, illustrates a function of the methods, apparatuses, and non-transitory computer-readable mediums. One or more such functions (“depicted functions”) can be implemented by computer program instructions; by special-purpose, hardware-based computer systems; by combinations of special purpose hardware and computer instructions; by combinations of general purpose hardware and computer instructions; and so on—one or more of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps are presented in order. According to some embodiments, an alternate order of the steps may be adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems, and methods herein described may be utilized and presented in a multitude of computer languages. Individual systems may be presented in one or more computer languages, and the computer language may be changed with ease at any point in the process or methods described above. One of ordinary skill in the art would appreciate that there are numerous computer languages the system could be provided in, and embodiments of the present disclosure are contemplated for use with any computer language.

The invention includes other illustrative embodiments (“Embodiments”) as follows.

Embodiment A1. A computer implemented method for automatically monitoring and deterring crime, comprising: processing a video feed obtained by a camera using an artificial intelligence module to detect one or more potential threats; assigning a threshold level to each of the one or more potential threats based upon severity of each of the one or more potential threats; assigning a deterrence score to each of one or more intervention measures for deterring the one or more potential threats; and comparing the threshold levels with the deterrence scores to determine if the one or more intervention measures are appropriate for deterring the one or more potential threats.

Embodiment A2. The method of embodiment A1, wherein the camera is motion activated and transmits the video feed to the artificial intelligence module when motion is detected, or wherein the artificial intelligence module is located on the camera.

Embodiment A3. The method of embodiment A1, wherein the

artificial intelligence module is trained to evaluate aggravating or mitigating circumstances to the one or more potential threats, wherein the aggravating or mitigating circumstances comprise one or more of presence of a weapon, speed or trajectory of the one or more potential threats, or frequency of crime in area being monitored by the camera.

Embodiment A4. The method of embodiment A1, further comprising: once the one or more potential threats are detected, transmitting to a user device evidence of the one or more potential threats and one or more recommended intervention measures to deter the one or more potential threats.

Embodiment A5. The method of embodiment A4, further comprising: once the one or more potential threats are detected, further transmitting to the user a one-time multifactor approval link, wherein the one-time multifactor approval link provides access to video footage of the one or more potential threats and a feedback mechanism for the user to approve or deny the one or more recommended intervention measures.

Embodiment A6. The method of embodiment A5, wherein if the user approves the one or more recommended intervention measures, the one or more recommended intervention measures are automatically deployed, wherein if the user denies the one or more recommended intervention measures, the one or more recommended intervention measures are not deployed.

Embodiment A7. The method of embodiment A1, wherein the one or more intervention measures comprise at least one of: one or more non-contact intervention measures; or one or more contact intervention measures, wherein the one or more non-contact intervention measures comprise at least one of two way voice or video, strobe light, siren, ammunition blanks, or air horn, wherein the one or more contact intervention measures comprise at least one of pepper spray or pepper balls, pellet or paint ball guns, rubber bullets, smoke bombs, or flashbang.

Embodiment A8. A non-transitory computer readable medium having program instructions stored thereon for automatically monitoring and deterring crime which, when executed by a processor, causes the processor to carry out the steps of: processing a video feed obtained by a camera using an artificial intelligence module to detect one or more potential threats; assigning a threshold level to each of the one or more potential threats based upon severity of each of the one or more potential threats; assigning a deterrence score to each of one or more intervention measures for deterring the one or more potential threats; and comparing the threshold levels with the deterrence scores to determine if the one or more intervention measures are appropriate for deterring the one or more potential threats.

Embodiment A9. The non-transitory computer readable medium of embodiment A8, wherein the camera is motion activated and transmits the video feed to the artificial intelligence module when motion is detected, or wherein the artificial intelligence module is located on the camera.

Embodiment A10. The non-transitory computer readable medium of embodiment A8, wherein the artificial intelligence module is trained to evaluate aggravating or mitigating circumstances to the one or more potential threats, wherein the aggravating or mitigating circumstances comprise one or more of presence of a weapon, speed or trajectory of the one or more potential threats, or frequency of crime in area being monitored by the camera.

Embodiment A11. The non-transitory computer readable medium of embodiment A8, further comprising: once the one or more potential threats are detected, transmitting to a user device evidence of the one or more potential threats and one or more recommended intervention measures to deter the one or more potential threats.

Embodiment A12. The non-transitory computer readable medium of embodiment A11, further comprising: once the one or more potential threats are detected, further transmitting to the user a one-time multifactor approval link, wherein the one-time multifactor approval link provides access to video footage of the one or more potential threats and a feedback mechanism for the user to approve or deny the one or more recommended intervention measures.

Embodiment A13. The non-transitory computer readable medium of embodiment A12, wherein if the user approves the one or more recommended intervention measures, the one or more recommended intervention measures are automatically deployed, wherein if the user denies the one or more recommended intervention measures, the one or more recommended intervention measures are not deployed.

Embodiment A14. The non-transitory computer readable medium of embodiment A8, wherein the one or more intervention measures comprise at least one of: one or more non-contact intervention measures; or one or more contact intervention measures, wherein the one or more non-contact intervention measures comprise at least one of two way voice or video, strobe light, siren, ammunition blanks, or air horn, wherein the one or more contact intervention measures comprise at least one of pepper spray or pepper balls, pellet or paint ball guns, rubber bullets, smoke bombs, or flashbang.

Embodiment A15. An apparatus for automatically monitoring and deterring crime, comprising: one or more processors; and memory accessible by the one or more processors, the memory storing instructions that when executed by the one or more processors, cause the apparatus to perform the method of: processing a video feed obtained by a camera using an artificial intelligence module to detect one or more potential threats; assigning a threshold level to each of the one or more potential threats based upon severity of each of the one or more potential threats; assigning a deterrence score to each of one or more intervention measures for deterring the one or more potential threats; and comparing the threshold levels with the deterrence scores to determine if the one or more intervention measures are appropriate for deterring the one or more potential threats.

Embodiment A16. The apparatus of embodiment A15, wherein the camera is motion activated and transmits the video feed to the artificial intelligence module when motion is detected, or wherein the camera comprises the or more processors, the memory, and the artificial intelligence module.

Embodiment A17. The apparatus of embodiment A15, wherein the artificial intelligence module is trained to evaluate aggravating or mitigating circumstances to the one or more potential threats, wherein the aggravating or mitigating circumstances comprise one or more of presence of a weapon, speed or trajectory of the one or more potential threats, or frequency of crime in area being monitored by the camera.

Embodiment A18. The apparatus of embodiment A15, further comprising: once the one or more potential threats are detected, transmitting to a user device evidence of the one or more potential threats and one or more recommended intervention measures to deter the one or more potential threats.

Embodiment A19. The apparatus of embodiment A18, further comprising: once the one or more potential threats are detected, further transmitting to the user a one-time multifactor approval link, wherein the one-time multifactor approval link provides access to video footage of the one or more potential threats and a feedback mechanism for the user to approve or deny the one or more recommended intervention measures.

Embodiment A20. The apparatus of embodiment A19, wherein if the user approves the one or more recommended intervention measures, the one or more recommended intervention measures are automatically deployed, wherein if the user denies the one or more recommended intervention measures, the one or more recommended intervention measures are not deployed.

Embodiment B1. A computer implemented method for automatically monitoring and deterring crime, comprising: monitoring by an artificial intelligence module one or more areas; determining by the artificial intelligence module to recommend one or more intervention measures from a plurality of possible intervention measures for the one or more areas; determining by the artificial intelligence module that approvals are needed from one or more designated approvers for use of the one or more recommended intervention measures; and seeking approval by the artificial intelligence module from the one or more designated approvers for use of the one or more recommended intervention measures.

Embodiment B2. The method of Embodiment B1, wherein, based on monitoring the one or more areas, the artificial intelligence module identifies one or more potential threats in the one or more areas.

Embodiment B3. The method of Embodiment B2, wherein the artificial intelligence module determines the one or more recommend intervention measures from the plurality of possible intervention measures based on the one or more identified potential threats in the one or more areas.

Embodiment B4. The method of Embodiment B2, wherein the artificial intelligence module determines the needed approvals based on the one or more identified potential threats in the one or more areas, the one or more recommend intervention measures, or a combination thereof.

Embodiment B5. The method of Embodiment B1, wherein the artificial intelligence module further determines an order for seeking approvals from two or more of the designated approvers.

Embodiment B6. The method of Embodiment B5, wherein the artificial intelligence module determines the order for seeking approvals from the two or more designated approvers based on one or more potential threats identified in the one or more areas, the one or more recommended intervention measures, or a combination thereof.

Embodiment B7. The method of Embodiment B5, wherein the order for seeking approvals from the two or more designated approvers includes seeking approval of a first designated approver before seeking approval of a second designated approver.

Embodiment B8. The method of Embodiment B1, wherein the artificial intelligence module determines the needed approvals and an order for seeking the needed approvals based on one or more potential threats identified in the one or more areas, the one or more recommend intervention measures, or a combination thereof.

Embodiment B9. The method of Embodiment B1, wherein determining the one or more recommended intervention measures by the artificial intelligence module comprises: assigning a deterrence score to each of the plurality of intervention measures for deterring one or more potential threats identified in the one or more areas, wherein seeking approval by the artificial intelligence module from the one or more designated approvers for use of the one or more recommended intervention measures includes forwarding the deterrence score for each of the one or more recommended intervention measures to the one or more designated approvers.

Embodiment B10. The method of Embodiment B1, wherein monitoring by the artificial intelligence module one or more areas comprises:
processing by the artificial intelligence module a video feed obtained by a camera to detect one or more potential threats in the one or more areas.

Embodiment B11. The method of Embodiment B10, wherein the camera is motion activated and transmits the video feed to the artificial intelligence module when motion is detected, or wherein the artificial intelligence module is located on the camera.

Embodiment B12. The method of Embodiment B1, wherein the artificial intelligence module is trained to evaluate aggravating or mitigating circumstances to one or more potential threats in the one or more areas.

Embodiment B13. The method of Embodiment B1, wherein the one or more designated approvers comprises two or more of: a guard, a lead guard, a monitor of security monitoring company, a manager of a security monitoring company, a customer, or a designated senior user.

Embodiment B14. A non-transitory computer readable medium having program instructions stored thereon for automatically monitoring and deterring crime which, when executed by a processor, causes the processor to carry out the steps of: monitoring by an artificial intelligence module one or more areas; determining by the artificial intelligence module to recommend one or more intervention measures from a plurality of possible intervention measures for the one or more areas; determining by the artificial intelligence module that approvals are needed from one or more designated approvers for use of the one or more recommended intervention measures; and seeking approval by the artificial intelligence module from the one or more designated approvers for use of the one or more recommended intervention measures.

Embodiment B15. The non-transitory computer readable medium of Embodiment B14, wherein, based on monitoring the one or more areas, the artificial intelligence module identifies one or more potential threats in the one or more areas.

Embodiment B16. The non-transitory computer readable medium of Embodiment B15, wherein the artificial intelligence module determines the one or more recommend intervention measures from the plurality of possible intervention measures based on the one or more identified potential threats in the one or more areas.

Embodiment B17. The non-transitory computer readable medium of Embodiment B15, wherein the artificial intelligence module determines the needed approvals based on the one or more identified potential threats in the one or more areas, the one or more recommend intervention measures, or a combination thereof.

Embodiment B18. An apparatus for automatically monitoring and deterring crime, comprising: one or more processors; and memory accessible by the one or more processors, the memory storing instructions that when executed by the one or more processors, cause the apparatus to perform the method of: monitoring by an artificial intelligence module one or more areas; determining by the artificial intelligence module to recommend one or more intervention measures from a plurality of possible intervention measures for the one or more areas; determining by the artificial intelligence module that approvals are needed from one or more designated approvers for use of the one or more recommended intervention measures; and seeking approval by the artificial intelligence module from the one or more designated approvers for use of the one or more recommended intervention measures.

Embodiment B19. The apparatus of Embodiment B18, wherein the artificial intelligence module further determines an order for seeking approvals from two or more of the designated approvers.

Embodiment B20. The apparatus of Embodiment B18, wherein the artificial intelligence module determines the needed approvals and an order for seeking the needed approvals based on one or more potential threats identified in the one or more areas, the one or more recommend intervention measures, or a combination thereof.

Embodiments illustrated under any heading or in any portion of the disclosure may be combined with embodiments illustrated under the same or any other heading or other portion of the disclosure unless otherwise indicated herein or otherwise clearly contradicted by context. For example, and without limitation, embodiments described in dependent claim format for a given embodiment (e.g., the given embodiment described in independent claim format) may be combined with other embodiments (described in independent claim format or dependent claim format).

While multiple embodiments are disclosed, still other embodiments of the present disclosure will become apparent to those of ordinary skill in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

The descriptions of the various embodiments have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application, or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions, or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects.

Numerous modifications, alterations, and changes to the described embodiments are possible without departing from the scope of the present invention defined in the claims. It is intended that the present invention need not be limited to the described embodiments, but that it has the full scope defined by the language of the following claims, and equivalents thereof.

What is claimed is:

1. A computer implemented method for automatically monitoring and deterring crime, comprising:
processing a video feed obtained by a camera using an artificial intelligence module to detect one or more potential threats;
assigning a threshold level to each of the one or more potential threats based upon severity of each of the one or more potential threats;
assigning a deterrence score to each of one or more intervention measures for deterring the one or more potential threats; and
comparing the threshold levels with the deterrence scores to determine if the one or more intervention measures are appropriate for deterring the one or more potential threats.

2. The method of claim 1, wherein the camera is motion activated and transmits the video feed to the artificial intelligence module when motion is detected, or
wherein the artificial intelligence module is located on the camera.

3. The method of claim 1, wherein the artificial intelligence module is trained to evaluate aggravating or mitigating circumstances to the one or more potential threats, wherein the aggravating or mitigating circumstances comprise one or more of presence of a weapon, speed or trajectory of the one or more potential threats, or frequency of crime in area being monitored by the camera.

4. The method of claim 1, further comprising:
once the one or more potential threats are detected, transmitting to a user device evidence of the one or more potential threats and one or more recommended intervention measures to deter the one or more potential threats.

5. The method of claim 4, further comprising:
once the one or more potential threats are detected, further transmitting to the user a one-time multifactor approval link, wherein the one-time multifactor approval link provides access to video footage of the one or more potential threats and a feedback mechanism for the user to approve or deny the one or more recommended intervention measures.

6. The method of claim 5, wherein if the user approves the one or more recommended intervention measures, the one or more recommended intervention measures are automatically deployed,
wherein if the user denies the one or more recommended intervention measures, the one or more recommended intervention measures are not deployed.

7. The method of claim 1, wherein the one or more intervention measures comprise at least one of:
one or more non-contact intervention measures; or
one or more contact intervention measures,
wherein the one or more non-contact intervention measures comprise at least one of two way voice or video, strobe light, siren, ammunition blanks, or air horn,
wherein the one or more contact intervention measures comprise at least one of pepper spray or pepper balls, pellet or paint ball guns, rubber bullets, smoke bombs, or flashbang.

8. A non-transitory computer readable medium having program instructions stored thereon for automatically monitoring and deterring crime which, when executed by a processor, causes the processor to carry out the steps of:
processing a video feed obtained by a camera using an artificial intelligence module to detect one or more potential threats;
assigning a threshold level to each of the one or more potential threats based upon severity of each of the one or more potential threats;
assigning a deterrence score to each of one or more intervention measures for deterring the one or more potential threats; and
comparing the threshold levels with the deterrence scores to determine if the one or more intervention measures are appropriate for deterring the one or more potential threats.

9. The non-transitory computer readable medium of claim 8, wherein the camera is motion activated and transmits the video feed to the artificial intelligence module when motion is detected, or
wherein the artificial intelligence module is located on the camera.

10. The non-transitory computer readable medium of claim 8, wherein the artificial intelligence module is trained to evaluate aggravating or mitigating circumstances to the one or more potential threats, wherein the aggravating or mitigating circumstances comprise one or more of presence of a weapon, speed or trajectory of the one or more potential threats, or frequency of crime in area being monitored by the camera.

11. The non-transitory computer readable medium of claim 8, further comprising:
once the one or more potential threats are detected, transmitting to a user device evidence of the one or more potential threats and one or more recommended intervention measures to deter the one or more potential threats.

12. The non-transitory computer readable medium of claim 11, further comprising:
once the one or more potential threats are detected, further transmitting to the user a one-time multifactor approval link, wherein the one-time multifactor approval link provides access to video footage of the one or more potential threats and a feedback mechanism for the user to approve or deny the one or more recommended intervention measures.

13. The non-transitory computer readable medium of claim 12, wherein if the user approves the one or more recommended intervention measures, the one or more recommended intervention measures are automatically deployed,
wherein if the user denies the one or more recommended intervention measures, the one or more recommended intervention measures are not deployed.

14. The non-transitory computer readable medium of claim 8, wherein the one or more intervention measures comprise at least one of:
one or more non-contact intervention measures; or
one or more contact intervention measures,
wherein the one or more non-contact intervention measures comprise at least one of two way voice or video, strobe light, siren, ammunition blanks, or air horn,
wherein the one or more contact intervention measures comprise at least one of pepper spray or pepper balls, pellet or paint ball guns, rubber bullets, smoke bombs, or flashbang.

15. An apparatus for automatically monitoring and deterring crime, comprising: one or more processors; and memory accessible by the one or more processors, the memory storing instructions that when executed by the one or more processors, cause the apparatus to perform the method of:
processing a video feed obtained by a camera using an artificial intelligence module to detect one or more potential threats;
assigning a threshold level to each of the one or more potential threats based upon severity of each of the one or more potential threats;
assigning a deterrence score to each of one or more intervention measures for deterring the one or more potential threats; and
comparing the threshold levels with the deterrence scores to determine if the one or more intervention measures are appropriate for deterring the one or more potential threats.

16. The apparatus of claim 15, wherein the camera is motion activated and transmits the video feed to the artificial intelligence module when motion is detected, or
wherein the camera comprises the or more processors, the memory, and the artificial intelligence module.

17. The apparatus of claim 15, wherein the artificial intelligence module is trained to evaluate aggravating or mitigating circumstances to the one or more potential threats, wherein the aggravating or mitigating circumstances comprise one or more of presence of a weapon, speed or trajectory of the one or more potential threats, or frequency of crime in area being monitored by the camera.

18. The apparatus of claim 15, further comprising:
once the one or more potential threats are detected, transmitting to a user device evidence of the one or more potential threats and one or more recommended intervention measures to deter the one or more potential threats.

19. The apparatus of claim 18, further comprising:
once the one or more potential threats are detected, further transmitting to the user a one-time multifactor approval link, wherein the one-time multifactor approval link provides access to video footage of the one or more potential threats and a feedback mechanism for the user to approve or deny the one or more recommended intervention measures.

20. The apparatus of claim 19, wherein if the user approves the one or more recommended intervention measures, the one or more recommended intervention measures are automatically deployed,
wherein if the user denies the one or more recommended intervention measures, the one or more recommended intervention measures are not deployed.
